(19) United States
(12) Patent Application Publication
(10) Pub. No.: US 2026/0228407 A1
(43) Pub. Date: Aug. 6, 2026

(54) METHOD FOR BACKEND PHYSICAL DESIGN AND CIRCUIT LAYOUT

(71) Applicant: MEDIATEK INC., Hsinchu City (TW)

(72) Inventors: Yi-Chun Tsai, Hsinchu City (TW); Meng-Fu Yu, Hsinchu City (TW); Shuyuan Zhang, Singapore (SG); Po-Wen Shih, Hsinchu City (TW); Chieh-Jou Cheng, Hsinchu City (TW); Yi-Feng Chen, Hsinchu City (TW); Chieh-Ching Chien, Hsinchu City (TW); Shih-Yun Lin, Hsinchu City (TW); Vanessa Kim Ann Sim, Singapore (SG); Jiayi Xu, Singapore (SG); Kin Hooi Dia, Hsinchu City (TW); Jen-Hang Yang, Hsinchu City (TW)

(73) Assignee: MEDIATEK INC., Hsinchu City (TW)

(21) Appl. No.: 19/449,454

(22) Filed: Jan. 15, 2026

Related U.S. Application Data
(60) Provisional application No. 63/745,390, filed on Jan. 15, 2025.

(51) Int. Cl. G06F 30/392; G06F 30/323

(52) U.S. Cl. CPC G06F 30/392; G06F 30/323

(57) ABSTRACT

The present invention provides a backend physical design method, which includes the step of: performing APR according to a gate-level netlist file to generate a GDS file, wherein the GDS file comprises a circuit layout; configuring a dummy blockage around a critical path of the circuit layout; performing dummy metal insertion on the circuit layout to add dummy metal into the circuit layout, wherein dummy metal is not added to a region of the dummy blockage in the circuit layout; and generating an updated GDS file, which comprises the circuit layout and the dummy metal.

### CROSS REFERENCE TO RELATED APPLICATIONS

This application claims the benefit of U.S. Provisional Application No. 63/745,390, filed on Jan. 15, 2025. The content of the application is incorporated herein by reference.

### BACKGROUND

With the evolution of integrated circuit (IC) process technology, the width of conductive wires continues to shrink, making the resistance effect of metal wires increasingly significant to circuit performance. In the existing semiconductor design flow, if a problem of timing not meeting standards or excessive IR drop is found in a critical path after the automatic placement and routing (APR) stage, conventional techniques usually adopt the following two means for correction. First, adopting a method of enlarging metal width, that is, directly reducing resistance by increasing the cross-sectional area of the wire. Second, performing engineering change order (ECO) routing, which physically reduces resistance by cutting and reconnecting the original wires or changing the routing path to shorten the wire length.

However, the above-mentioned conventional techniques have several technical defects in practical application. First, since the traditional ECO process is extremely cumbersome, engineers must modify the design, and perform subsequent verification for each timing violation point. This correction process usually takes several days, causing a great burden on the project execution time for projects with tight schedules. Second, whether increasing the wire width or re-routing, it will directly change the completed APR design and the signal layout pattern. Such substantial alteration to the original stable design easily interferes with the electrical characteristics of adjacent circuits, and even generates new design rule check (DRC) violations. Third, the current correction flow requires returning to the design phase to make structural changes after a problem is found, rather than optimizing without changing the original design, resulting in low design efficiency.

### SUMMARY

Therefore, one of the objectives of the present invention is to provide a circuit design method that can effectively reduce the resistance value of wires on a critical path and/or other paths without performing ECO, so that the timing and voltage drop of the critical path and/or other paths meet the standards, thereby solving the problems described in the prior art.

In one embodiment of the present invention, a backend physical design method comprises the step of: performing APR according to a gate-level netlist file to generate a GDS file, wherein the GDS file comprises a circuit layout; configuring a dummy blockage around a critical path of the circuit layout; performing dummy metal insertion on the circuit layout to add dummy metal into the circuit layout, wherein dummy metal is not added to a region of the dummy blockage in the circuit layout; and generating an updated GDS file, which comprises the circuit layout and the dummy metal.

In one embodiment of the present invention, a backend physical design method comprises the steps of: performing APR according to a gate-level netlist file to generate a GDS file, wherein the GDS file comprises a circuit layout; performing dummy metal insertion on the circuit layout to add dummy metal into the circuit layout to generate a first updated GDS file, which comprises the circuit layout and the dummy metal; performing static timing analysis on the updated GDS file to generate a timing report; if the timing report indicates that a critical path has a timing violation, configuring a dummy blockage around a critical path of the circuit layout of the GDS file; and performing dummy metal insertion on the circuit layout to add dummy metal into the circuit layout, wherein dummy metal is not added to a region of the dummy blockage in the circuit layout, so as to generate a second updated GDS file, which comprises the circuit layout and the dummy metal.

In one embodiment of the present invention, a circuit layout comprising a first area and a second area is disclosed. The first area comprises a critical path, and the second area does not comprise any critical path, wherein a metal density of the first area is lower than a metal density of the second area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a circuit backend physical design according to an embodiment of the present invention.

FIG. 2 is a schematic diagram of adding dummy metal in a layout.

FIG. 3 is a schematic diagram of configuring a BEOL dummy blockage around a critical path to reduce metal density according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to ...”. The terms “couple” and “couples” are intended to mean either an indirect or a direct electrical connection. Thus, if a first device couples to a second device, that connection may be through a direct electrical connection, or through an indirect electrical connection via other devices and connections.

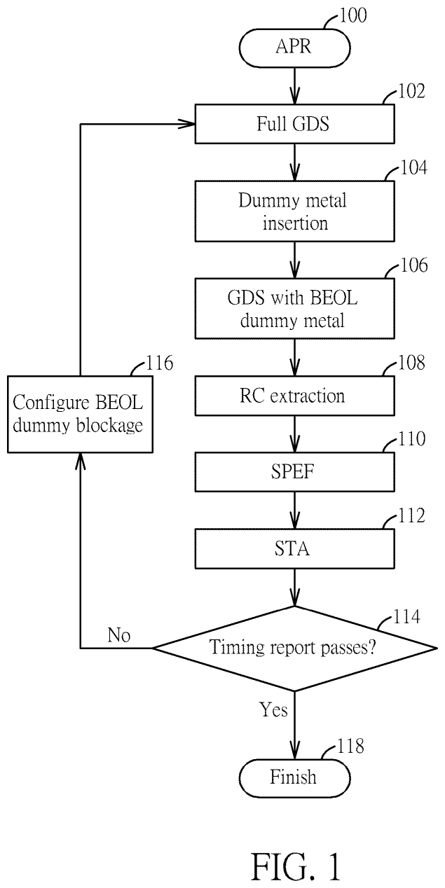

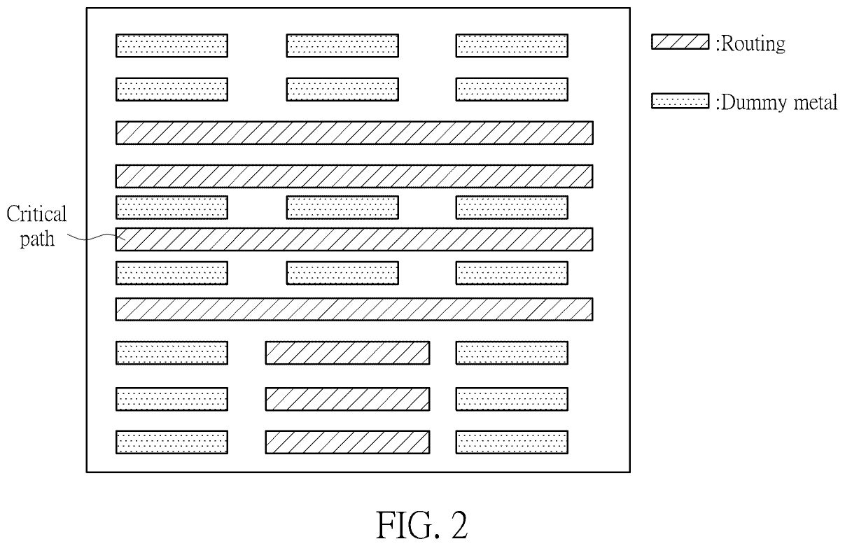

FIG. 1 is a flowchart of a circuit backend physical design according to an embodiment of the present invention, wherein this flow is executed by system software of Electronic Design Automation (EDA) tools. As shown in FIG. 1, in Step 100, automatic placement and routing (APR) is performed, that is, standard cells are placed onto a circuit layout according to a gate-level netlist, design constraints, and physical and timing libraries, and automatic connection is performed to complete circuit logic connection. In Step 102, the design completed by APR is exported into a GDSII format to generate a full layout file (Full graphic data system (GDS) file), which contains graphic information of all layers on the chip. In Step 104, in order to meet the flatness requirements of chemical mechanical polishing (CMP) in the process, dummy metal without electrical functions (i.e., floating) is added in blank areas where metal density is too low, wherein the dummy metal and the routing are the same metal layer, and the dummy metal is not electrically connected to the routing. In addition, the metal density needs to comply with the content of the design rule. For example, the proportion of the metal area (including routing and dummy metal) within an area range of 50 um*50 um is between 10%-50% (this is only an example). In order to stabilize the flatness requirements of CMP, the metal density at this time will be close to the upper limit of 50% of the design rule. Taking the circuit layout of FIG. 2 for explanation, it includes the routing generated in the APR stage, and dummy metal is inserted into the blank areas around the routing.

In Step 106, an updated GDS file including dummy metal is generated. This file is the file actually sent to the mask factory for production, and it contains the original routing of the circuit and the subsequently filled dummy metal.

In Step 108, resistance and capacitance in the circuit are calculated according to the geometric graphics (e.g., length, width, spacing, density) on the GDS.

In Step 110, the data calculated by RC extraction is saved as a Standard Parasitic Exchange Format (SPEF) file. This file describes the resistance values and capacitance values of every wire on the chip.

In Step 112, Static Timing Analysis (STA) is performed, reading the SPEF file and the netlist file, calculating the delay time of all paths, checking whether the clock frequency requirements (setup time, hold time) are met, and generating a timing report.

In Step 114, it is determined whether the setup time and hold time of a critical path comply with the requirements. If yes, the flow enters Step 118 to end this flow; and if not, the flow enters Step 116.

In this embodiment, the term ‘critical path’ refers to a signal path identified by the timing analysis tool (e.g., STA) as having a timing margin (slack) lower than a predetermined threshold or failing to meet a timing constraint. For example, a critical path may be a path having a negative slack (timing violation) or a positive slack that is close to zero (timing critical). It should be noted that the critical path is distinct from ‘non-critical paths’ or general routing, which typically satisfy timing requirements with sufficient margin.

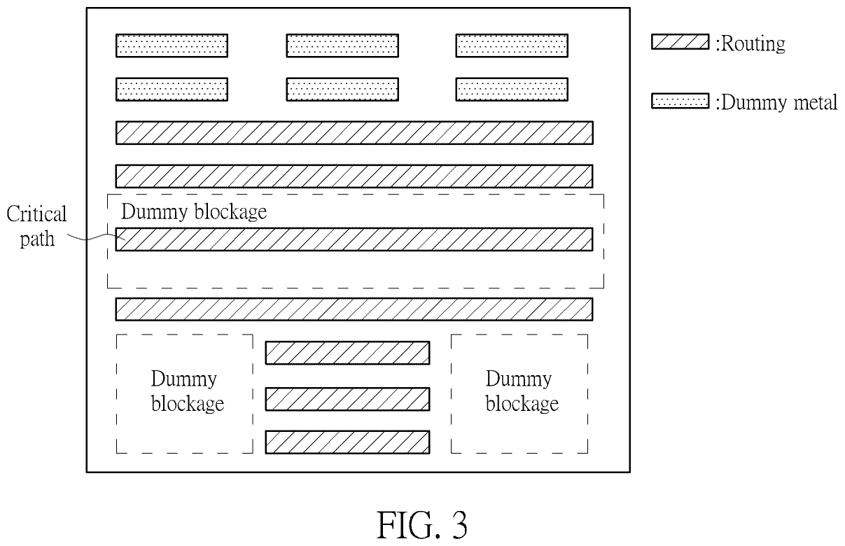

In Step 116, an adaptive backend-of-line (BEOL) dummy blockage is added to the GDS file, wherein the BEOL dummy blockage is added at least in the peripheral area of the critical path, and can also be additionally added around other routing. Taking FIG. 3 as an example for explanation, the peripheral area of the critical path and the surroundings of other routings are all added with the adaptive BEOL dummy blockage. In this embodiment, the BEOL dummy blockage is a layer, which is only used to prevent dummy metal from being inserted/added in this area, and will not affect the original routing. Then, the flow returns to Step 102.

Next, after the flow re-enters Step 104, dummy metal without electrical functions is added in blank areas where metal density is too low. However, since the BEOL dummy blockage has been set in part of the layout area at this time, the dummy metal will only be added in areas without the BEOL dummy blockage. As shown in FIG. 3, since the surroundings of the critical path are all BEOL dummy blockages, the density of dummy metal around the critical path will be lower than the density of dummy metal in other areas (i.e., areas not around the critical path) (the metal density around the critical path still needs to comply with the specifications of the design rule), or it can be said that the metal density including the critical path and the peripheral area will be lower than the metal density of other areas. Then, in Step 106, an updated GDS file including dummy metal is generated. This file is the file actually sent to the mask factory for production, and it contains the original routing of the circuit and the subsequently added dummy metal.

Next, after the flow re-enters Step 108, resistance and capacitance in the circuit are calculated according to the geometric graphics on the GDS file. In this embodiment, since the metal density around the critical path becomes lower, the resistance of the critical path will decrease, while the capacitance will increase slightly. Specifically, in the CMP process, the metal in the low-metal-density area is harder to be polished, resulting in the remaining metal lines being “thicker”. Thicker metal has a larger cross-sectional area, so the resistance is smaller. In addition, although thicker metal will cause the capacitance to rise slightly, since the magnitude of the resistance decrease is far greater than the magnitude of the capacitance increase, the overall RC delay of the critical path still decreases, thereby improving the timing performance and reducing the voltage drop (IR Drop). Therefore, since the RC delay is improved, the setup time and hold time of the critical path have a high probability of complying with requirements when performing the STA in Step 112, so as to complete the circuit backend physical design flow without performing ECO.

In addition, if there is still a timing violation in the timing report generated after reducing the dummy metal density around the critical path, ECO or other flows can be performed again.

In the flow shown in FIG. 1, the step of configuring the BEOL dummy blockage around the critical path to reduce the metal density is performed only when the critical path encounters a timing violation, but the present invention is not limited thereto. In other embodiments, the circuit backend physical design can configure the BEOL dummy blockage around the critical path or around other non-critical paths at the beginning to actively reduce the metal density, in order to pursue higher speed.

Briefly summarizing the present invention, in the circuit backend physical design of the present invention, by reducing the metal density around the critical path, the metal wire at that location can retain a thicker thickness during subsequent CMP, thereby physically reducing resistance to improve the timing of the critical path. In addition, since there is no need to enter the ECO stage in this embodiment, and there is no need to change the signal lines generated by APR, the circuit backend physical design can be completed quickly and efficiently.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A circuit backend physical design method, comprising:
performing automatic placement and routing (APR) according to a gate-level netlist file to generate a graphic data system (GDS) file, wherein the GDS file comprises a circuit layout;
configuring a dummy blockage around a critical path of the circuit layout;
performing dummy metal insertion on the circuit layout to add dummy metal into the circuit layout, wherein dummy metal is not added to a region of the dummy blockage in the circuit layout; and
generating an updated GDS file, which comprises the circuit layout and the dummy metal.

2. The circuit backend physical design method of claim 1, wherein a metal density of a first area comprising the critical path is lower than a metal density of a second area of the circuit layout, wherein the second area does not comprise any critical path.

3. The circuit backend physical design method of claim 1, wherein a routing of the critical path and the dummy metal belong to a same metal layer.

4. A circuit backend physical design method, comprising:
performing automatic placement and routing (APR) according to a gate-level netlist file to generate a graphic data system (GDS) file, wherein the GDS file comprises a circuit layout;
performing dummy metal insertion on the circuit layout to add dummy metal into the circuit layout to generate a first updated GDS file, which comprises the circuit layout and the dummy metal;
performing static timing analysis on the updated GDS file to generate a timing report;
if the timing report indicates that a critical path has a timing violation, configuring a dummy blockage around the critical path of the circuit layout of the GDS file; and
performing a dummy metal insertion on the circuit layout to add dummy metal into the circuit layout, wherein dummy metal is not added to a region of the dummy blockage in the circuit layout, so as to generate a second updated GDS file, which comprises the circuit layout and the dummy metal.

5. The circuit backend physical design method of claim 4, wherein a metal density of a first area comprising the critical path is lower than a metal density of a second area of the circuit layout, wherein the second area does not comprise any critical path.

6. The circuit backend physical design method of claim 4, wherein a routing of the critical path and the dummy metal belong to a same metal layer.

7. A circuit layout, comprising:
a first area, comprising a critical path; and
a second area, not comprising any critical path;
wherein a metal density of the first area is lower than a metal density of the second area.

8. The circuit layout of claim 7, wherein the first area and the second area have the same size, and an area of dummy metal comprised in the first area is lower than an area of dummy metal comprised in the second area.

9. The circuit layout of claim 7, wherein no dummy metal is added around the critical path in the first area.

10. The circuit layout of claim 9, wherein the second area comprises an electrical path, and dummy metal is added around the electrical path.
